(19) United States
(12) Patent Application Publication
(10) Pub. No.: US 2008/0077569 A1
(43) Pub. Date: Mar. 27, 2008

(54) Integrated Search Service System and Method

(75) Inventors: Jung eun Lee, Seoul (KR); Dae young Kim, Seoul (KR); Jeong sik Jang, Kyunggi-do (KR); Sang seok Lee, Seoul (KR)

Correspondence Address: Law Office of Mark J. Spolyar, 38 Fountain Street, San Francisco, CA, 94114, US

(73) Assignee: Yahoo! Inc., a Delaware Corporation

(21) Appl. No.: 11/608,455

(22) Filed: Dec. 8, 2006

(30) Foreign Application Priority Data
Sep. 27, 2006 (KR) 10-2006-93999

(51) Int. Cl. G06F 17/30

(52) U.S. Cl. 707/5

(57) ABSTRACT

In particular embodiments, an integrated search system and method for clustering search results into a plurality of groups based on its contents, each of the groups linked by a representative image, is disclosed. The system includes a clustering engine, an image engine, a database, and a web server. The clustering engine is configured to cluster resources stored in the database into a plurality of groups, each group including resources related to a common topic. The image engine determines a representative image for each of the groups. The database stores information on resources included in each of the groups and a representative image for the group. In one embodiment, the web server is configured to provide a user a plurality of images, each representing a group of resources related to common topic, where as the number of resources included in each group increases, a size of a representative image for the group becomes larger. As such, a user can recognize the level of importance of popularity of topics associated with each group of resources by viewing its representative image.

### TECHNICAL FIELD

The present disclosure generally relates to electronic search systems.

### BACKGROUND

A conventional search engine, in response to a user's query, provides the user a list of resource locations categorized into several groups (e.g., a group of knowledge information, a group of blogs, a group of webpage, etc.). However, such a search engine provides a user with only information on the category of the group indicated by the resource locators. Therefore, a user may have to click each of the resource locators provided as search results in order to check the contents or topics linked by the resource locators. In addition, it is difficult to find resources related to popular topics unless a user clicks and checks many resource locators to recognize frequent appearing topics.

Also, when using the conventional search engine, it is difficult for a user to quickly and efficiently recognize which search results among the provided search results relate to the same topic because the user should click and check contents thereof to know about the topics. Therefore, the conventional search engine does not satisfy the user's demands to get information on current issues.

### SUMMARY

A feature of the present invention is to provide an integrated search service system and method, in which search results are classified into a plurality of groups, based on their contents, each group being represented by an image, the size of which is adjusted based on one or more attributes of the corresponding group of search results, such as the level of importance or popularity.

In accordance with one embodiment of the present invention, there is provided an integrated search system for clustering search results into a plurality of groups based on its contents, each of the groups linked by a representative image. The system comprises a clustering engine, an image extracting engine, and a web server. The clustering engine is configured to group resources stored in a database into a plurality of clusters, each of the clusters including resources relevant to a common topic. The image extracting engine is configured to determine a representative image for each of the clusters. The web server is configured to provide an array of representative images for the clusters, wherein the sizes of the representative images are adjusted based on one or more attributes of the clusters, such as a level of popularity of topics relevant to the clusters of resources.

In accordance with another embodiment of the present invention, an integrated search service method is provided. The resources stored in a database are grouped into a plurality of clusters, each of the clusters including resources relevant to a common topic. Then, a representative image for each of the clusters is determined. Finally, an array of representative images for the clusters is provided, wherein the sizes of the representative images are adjusted based on one or more attributes of the clusters, such as a level of popularity of topics relevant to the clusters of resources.

In accordance with another embodiment of the present invention, another integrated search service method is provided. In the method, a search query is first received. Then, the search is performed for searching resources relevant to the search query. Search results are grouped into a plurality of clusters, each of the clusters including resources relevant to a common topic. Then, a graphical representation of representative images for the clusters is provided to a user, wherein the sizes of the representative images are adjusted based on one or more attributes of the clusters of resources.

### BRIEF DESCRIPTION OF THE DRAWINGS

FIG. 1 shows a block diagram of an example integrated search service system in accordance with one embodiment of the present invention.

FIG. 2 illustrates a block diagram of an example cluster search system in accordance with one embodiment of the present invention.

FIG. 3 depicts an example format of a resource included in a database in accordance with one embodiment of the present invention.

FIG. 4 presents example clusters based on the contents of resources stored in a database in accordance with one embodiment of the present invention.

FIG. 5 describes an example webpage that provides a user with clusters of search results represented by its representative images in accordance with one embodiment of the present invention.

FIG. 6 shows a block diagram of an example category search system in accordance with one embodiment of the present invention.

FIG. 7 sets forth a block diagram of an emotion search system in accordance with one embodiment of the present invention.

FIG. 8 illustrates a flow chart of a method for providing an integrated search service in accordance with one embodiment of the present invention.

FIG. 9 shows an example webpage including images each representing a cluster of search results in accordance with one embodiment of the present invention.

FIG. 10 illustrates a flow chart of a method for providing a clustering search service in accordance with one embodiment of the present invention.

FIG. 11 depicts an example webpage including results of cluster search, category search and emotion search in accordance with one embodiment of the present invention.

FIG. 12 illustrates a computing system architecture, which may be used to implement a server according to one embodiment of the present invention.

### DESCRIPTION OF EXAMPLE EMBODIMENTS

Various embodiments of the present invention will be described in detail below with reference to the accompanying drawings. It will be apparent, however, that these embodiments may be practiced without some or all of these specific details. In other instances, well known process steps or elements have not been described in detail in order not to unnecessarily obscure the description of the invention.

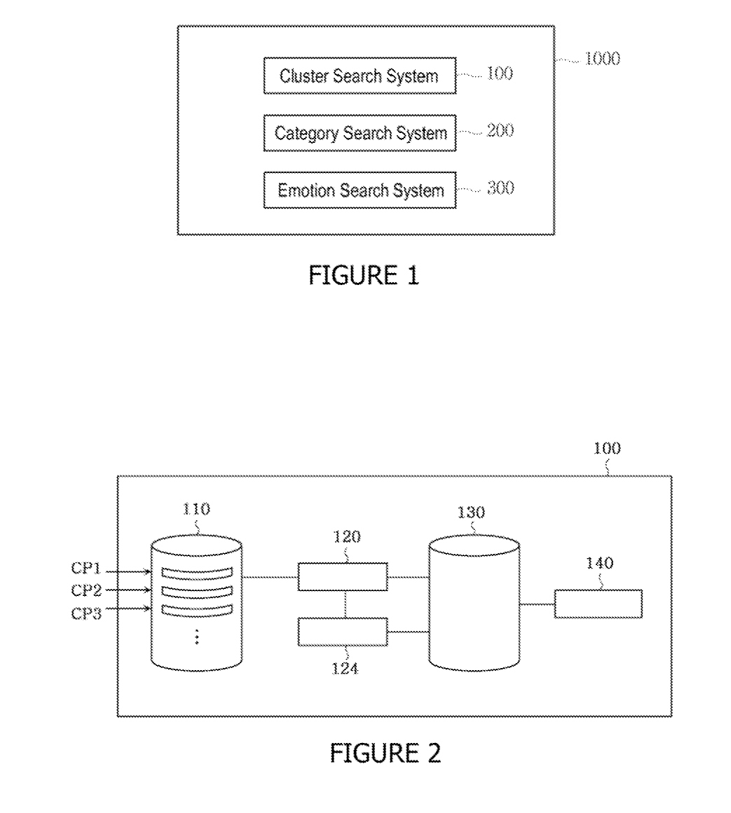

FIG. 1 shows a block diagram of an integrated search service system in accordance with one embodiment of the present invention. As shown in FIG. 1, the integrated search system 1000 includes a cluster search system 100, a category search system 200 and an emotion search system 300. Although the integrated search system 1000 is described to include the three system 100, 200 and 300, the system 1000 may choose to include only one or two out of the three systems as necessary. In the following, the systems 100, 200 and 300 will be described in more detail.

FIG. 2 shows a block diagram of a cluster search system 100 in accordance with one embodiment of the present invention. The cluster search system 100 includes a first database 110, a clustering engine 120, an image extracting engine 124, a second database 130 and a web server 140. In this embodiment, the first database 100 stores various resources, e.g., including information on news, provided from outside contents providers (CP1, CP2, CP3, etc.). Alternatively, the first database 110 may store resources, or data locators (such as Uniform Resource Locators (URLs) to resources, generated by an operator of the system alone or together with the ones provided from outside CPs. The resources stored in the database 110 are not limited to news information, but may include any type of data that provides a user with information on new and updated topics such as contents in blogs, Internet café, and any other types of web pages. The first database 110 may store the resources to be clustered into several groups based on the contents thereof. Further, the first database 110 may classify the stored resources based on its creation and/or update time. In this case, a user may select a specific time interval for which he/she wants to collect a group of resources such as news information, which will be described later in detail. Then, the clustering engine 120, the category search engine 220 and the emotion search engine 320 may perform clustering, category search, and emotion search operations, respectively, for the group of resources associated with the time interval selected by the user.

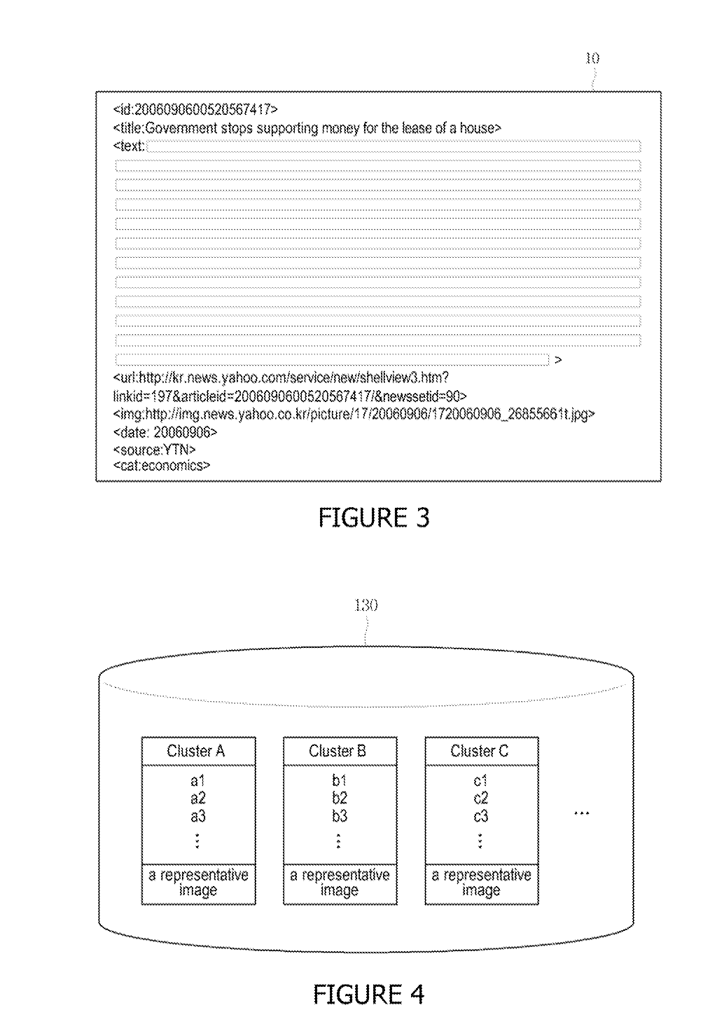

FIG. 3 shows an example format of a resource included in the first database 110 in accordance with one embodiment of the present invention. As shown in FIG. 3, the resource 10 includes news information stored in a format of text file, which includes a resource id, a title, content text, an URL, an image resource locator, a generation and/or update time, a source of the resource, and a category of the resource. The first database 110 may store the resource to be clustered into an appropriate group by referring to the various information such as category and generation time of the resource as illustrated in FIG. 3.

The clustering engine 120 performs a clustering of the resources stored in the first database 110. Particularly, the clustering engine 120 divides the resources into a plurality of clusters, each cluster including resources related to a common topic. The clustering engine 120 may use any suitable clustering algorithm, a detailed explanation of which will be omitted in this disclosure. In one embodiment, the clustering engine 120 clusters the resources in the first database 110 by determining the level of similarity of one resource to the other resources. For example, the clustering engine 120 calculates occurrences of similar terms or keywords, e.g., between two resources a1 and a2 stored in the first database 110. If the number of occurrences is higher than a predetermined value, then the clustering engine 120 determines that the topics of the two resources are similar to each other, and clusters the resources a1 and a2 into a same cluster A, as shown in FIG. 4.

As such, the clustering engine 120 performs a clustering of resources stored in the first database 110 by determining the similarity of resource contents. Then, the clustering engine 120 stores in the second database 130 information on a result of clustering resources, i.e., which resources are included in which clusters. FIG. 4 shows an example data structure stored in the second database 130 where a plurality of clusters such as cluster A, B and C. As shown in FIG. 4, each of the clusters has a plurality of resources clustered based on its contents. Further, each of the clusters is indicated or linked by a representative image, which will be explained in detail below.

Referring to FIG. 2, the image extracting engine 124 is configured to determine representative images for the clusters, which are determined by the clustering engine 120 as described above. In one embodiment, the image extracting engine 124 checks whether each of the resources included in the clusters has a resource locator to an image or not, and then determines an image that occurs first in resources included in a cluster as its representative image. For example, assume that the image engine 124 determines a representative image of a cluster A including twenty resources a1 to a20. The image extracting engine 124 first checks whether the resource a1 has an image resource locator. If the resource a1 has an image resource locator, the image extracting engine 124 determines an image indicated by the image resource locator as a representative image of the cluster A. If the resource a1 does not have any image resource locator, the image extracting engine 124 sequentially checks the contents of the next resources a2 to a20 until it finds an image resource locator. Other implementations are possible. For example, a representative image for a cluster may be manually selected based on an editorial process.

If it is determined that any one of the resources a1 to a20 does not have an image resource locator, the image extracting engine 124 may select a title of any one of the resources included in the cluster as a representative title. For example, if any one of the resources a1 to a20 does not have an image resource locator, the image engine 124 may select a title of a first resource, i.e., the resource a1, as a representative title of the cluster A, as an alternative to a representative image. Although a title of a first resource in a cluster is determined as a representative title for the cluster in this embodiment, it is clearly understood that any other criteria for determining a representative title out of those of the resources included in the cluster can be employed. In FIG. 4, while the clusters A and B are indicated or linked by respective representative images that are extracted from image resource locators included in their resources, the cluster C is indicated by a representative title that is extracted from one of title fields of their resources.

The web server 140 is configured to provide a user with a webpage including an array of representative images and/or titles each of which represents a cluster of resources clustered based on its contents, which are stored in the second database 130. Since a representative image or title is linked to a list of resource locators to resources included in a cluster associated with the representative image, if a user clicks on the image, the web server 140 refreshes the webpage or provides a new webpage to show the list of resource locators to resources included in the cluster associated with the representative image. For the purpose of linking a representative image to a list of resource locators to relevant resources, any suitable implementation such as including a link tag for the image in the web page and/or using a mouse click function may be employed.

The size of the representative images or titles may be adjusted depending on one or more attributes of the clusters, such as the level of importance or popularity of topics or contents included in the corresponding clusters. In one embodiment, the level of popularity of topics may be determined based on the numbers of resources included in the clusters. For example, if the clusters A, B, and C in FIG. 4 include 20 resources, 8 resources and 12 resources, respectively, the ratio of the sizes of representative images for the clusters A, B, and C can be determined to be 20:8:12. That is, the more resources are included in a cluster, the larger a representative image of the cluster becomes.

As shown in FIG. 4, if the cluster C is indicated by a representative title instead of a representative image, the web server 140 may modify a font size of the title based on the level of importance or popularity of contents included in the cluster C. As discussed above, the level of popularity of topics may be determined based on the numbers of resources included in the cluster C. Further, if a user clicks one of the representative images and/or titles included in the webpage provided by the web server 140, then the web server 140 may provide a list of resource locators to the resources associated with the representative image or title.

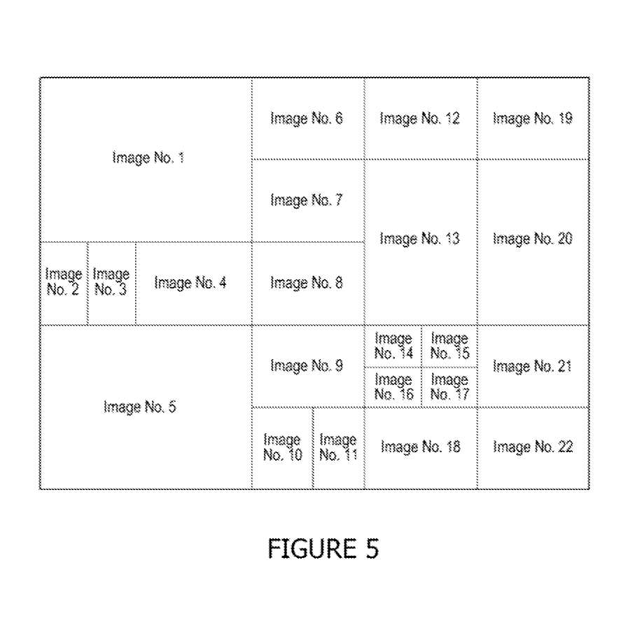

FIG. 5 shows a webpage including an array of representative images for clusters of resources that are provided to a user as search results in accordance with one embodiment of the present invention. As shown in FIG. 5, since representative images for corresponding clusters of resources are provided to a user instead of a list of resource locators, the user can easily grasp what the topics included in the resources are. In addition, since the web page includes a plurality of images each having a different size determined on the importance or popularity level, a user can recognize how important or popular the topics associated with the images are. For example, as shown in FIG. 5, the user can recognize that the largest number of resources are associated with an image No. 5 based on the fact that the size of the image No. 5 is the largest. That is, a user may recognize that the resources associated with the image No. 5 include the most popular topic.

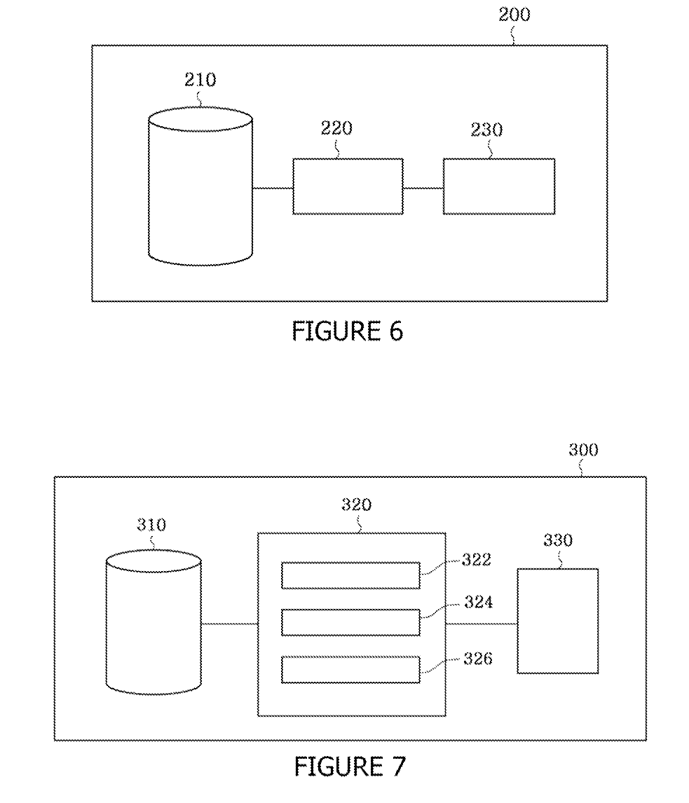

FIG. 6 shows a detailed configuration of the category search system 200 in accordance with one embodiment of the present invention. As illustrated in FIG. 6, the category search system 200 includes a database 210, a category search engine 220, and a web server 230. The database 210 and web server 230 have similar functions to those of the cluster search system 100 as described with reference to FIG. 2, and therefore a detailed explanation thereof will be omitted. The category search engine 220 performs a categorization of resources stored in the database 210. In one embodiment, the category search engine 200 determines a category which each of the resources falls within, e.g., by employing a machine learning algorithm that is well known in the art. Then, the categorized resources, i.e., search results, are provided to a user through the web server 230.

FIG. 7 shows a block diagram of the emotion search system 300 in accordance with one embodiment of the present invention. The emotion search system 300 includes an emotional search database 310 and an emotion search engine 320, which has an emotional word extracting module 322, an emotion scoring module 324, and a display module 326. The emotion search system 300 searches for target information based on emotional words included in resources stored in the emotional search database 310.

In one embodiment, the emotional search database 310 stores product reviews including evaluation results for products, e.g., which is obtained from a database of an online shopping mall. Further, the emotional word extracting module 322 stores a list of template emotional words, which is used in determining which emotional words are included in the product reviews stored in the emotional search database 310. That is, the emotional word extracting module 322 checks whether any one of emotional words included in the list is recited in the product reviews stored in the emotional search database 310. Then, the emotion scoring module 324 calculates evaluation scores for the product reviews by referring to a scoring table in which corresponding score values are assigned to the template emotional words. The scoring table may be stored in advance in the emotion scoring module 324. The display module 326 then composes a graphical representation for showing the evaluation scores for the product reviews, which is provided to a user as a part of search results.

For example, assuming that the list of template emotional words includes emotional words that are used in evaluating a quality of a product, such as “fast,” “satisfied,” “fine,” and “fantastic,” the emotional word extracting module 322 checks whether the product views stored in the emotional search database 310 include any one of the template emotional words. If the emotional word extracting module 322 extracts emotional words such as “best,” “fine” and “unsatisfied” in the product reviews, the emotion scoring module 324 assigns a corresponding evaluation score to each of the emotional words extracted by the extracting modules 322 by referring to the scoring table. For example, the emotion scoring module 324 gives evaluation scores of 10 points, 6 points, 2 points to the emotional words “the best,” “fine” and “unsatisfied,” respectively.

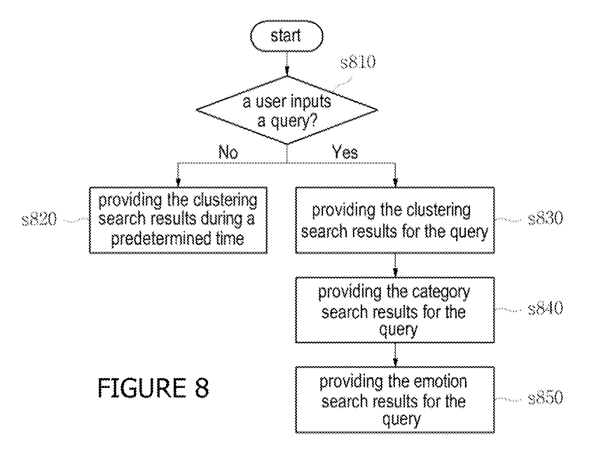

FIG. 8 shows a flow chart of a method for providing an integrated search service in accordance with one embodiment of the present invention. In this embodiment, the integrated search service includes a clustering search, a category search and an emotion search service. The clustering search service operates in a different way depending on whether or not a user inputs a query. That is, if the user has not inputted a query, the clustering search is performed on resources created and/or updated during a predetermined time. If the user has inputted a query, the clustering search is performed on resources relevant to the inputted query.

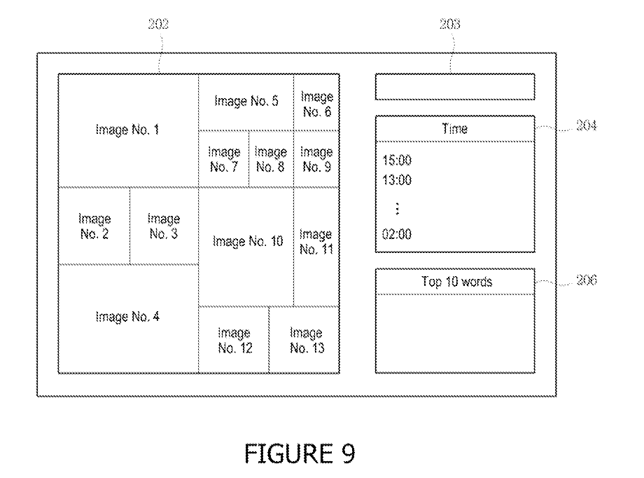

In particular, as illustrated in FIG. 8, it is checked whether a user inputs a query (operation 810). If the user does not input any query in the operation 810, a user is provided with search results that are obtained by performing a cluster search for resources created and/or updated during a predetermined time (operation 820). FIG. 9 shows an example webpage which is provided to a user as clustered search results in the operation 820. As shown in FIG. 9, the webpage includes a clustering window 202, a query input window 203, a time window 204 and a query ranking window 206. If a user selects one of predetermined time intervals in the time window 204, the clustering engine 120 extracts resources from the database 110 that are created or updated during the selected time intervals. Then, the clustering engine 120 clusters the extracted resources to generate an array of representative images for the clustered resources. The results of the clustering search, i.e., an array of representative images, are provided in the clustering window 202. As explained above, the sizes of the representative images for the clusters of resources may be adjusted depending on one or more attributes of the clusters, such as the level of importance or popularity of topics included in the resources.

Meanwhile, if the user inputs a query in the search system (operation 810), the clustering engine 120 searches for resources relevant to the inputted query, and clusters the searched resources. The clustering search performed in the operation 830 is identical to of the one performed in the operation 820 except that the clustering is performed for only resources associated with the inputted query. Thereafter, the category search and emotional search may be further performed (operations 840 and 850).

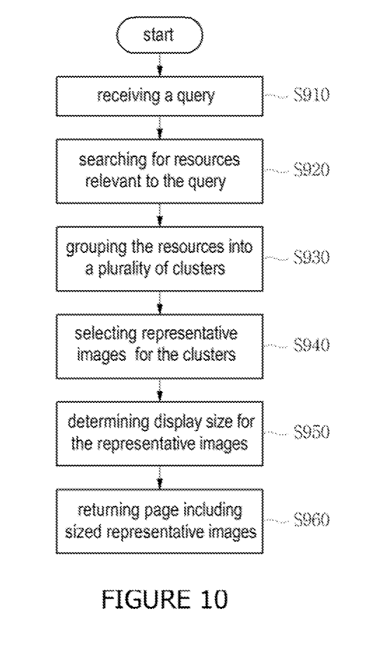

Although FIG. 8 shows an example method for providing an integrated search service including a clustering search, a category search and an emotion search service, at least one or any combinations of the search services may be provided to a user. FIG. 10 shows a flow chart of a method for providing a clustering service in accordance with one embodiment of the present invention.

As shown in FIG. 10, a clustering search engine receives a search query from a user (operation 910). Then, the search engine searches for resources relevant to the received query (operation 920). In operation 930, the searched resources are clustered into a plurality of clusters based on its contents. Then, representative images and/or titles for the clusters of resources are selected in a similar way as described with reference to FIG. 8 (operation 940). After selecting the representative images, display sizes of the representative images are determined that the sizes of the representative images are adjusted based on one of more attributes of the clusters of resources (operation 950). Then, in operation 960, a page including the sized representative images is provided to the user.

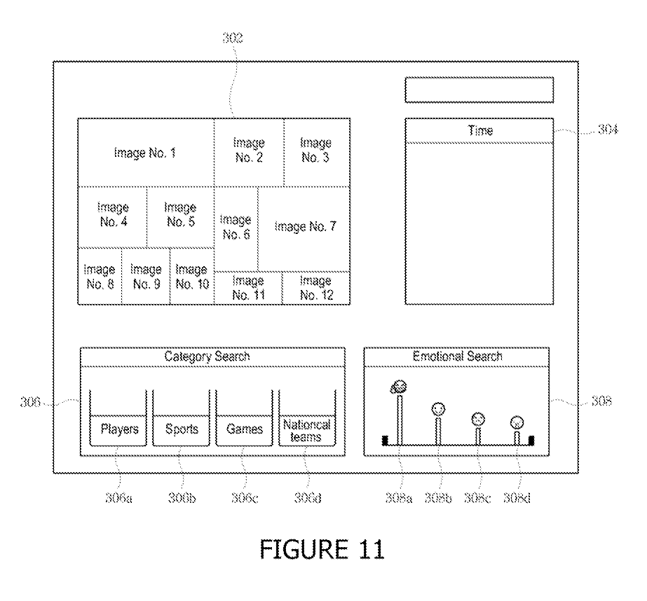

FIG. 11 shows an example webpage that are generated as results of performing the operations 830, 840 and 850. Referring to FIG. 11, the webpage includes a clustering window 302, a time window 304, a category search window 306 and an emotional search window 308. As shown in FIG. 11, if the user inputs a query including “football,” the search engine database gathers resources relevant to the term “football.” Then, the clustering engine 120 performs a clustering search for the resources stored in the search engine database as described above, and the results of clustering search, i.e., an array of representative images for the clustered resources are provided in the clustering window 302. Further, the category search window 306 provides the results of category search. AS shown in FIG. 11, the category search window 306 shows the categories (e.g., football player 306a, sport 306b, computer game 306c, and national athlete 306d) of the searched resources in a graphical representation where each of the categories is depicted as a bucket containing a number of balls proportional to the number of resources falling in the category. In addition, the emotional search window 308 shows the results of emotional search in a graphical representation where four bar graphs 308a, 308b, 308 c and 308 d are illustrated to represent evaluation scores for product reviews related to the query including “football.”

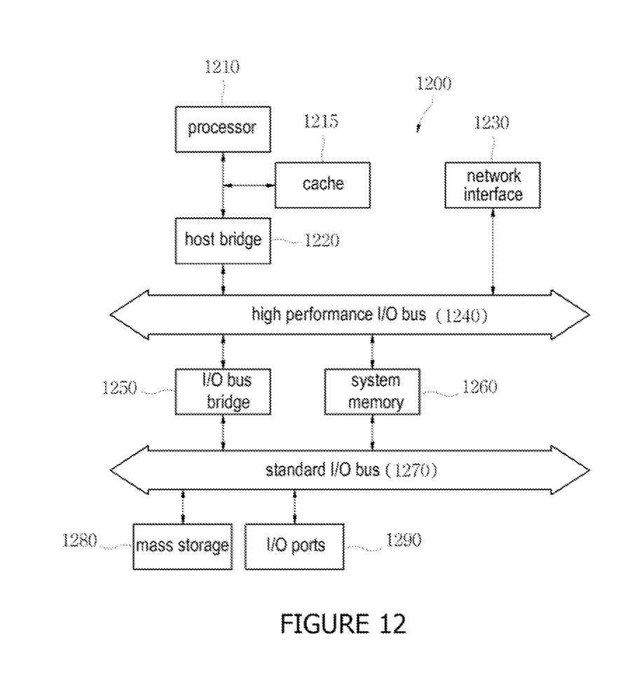

While the methods of the present invention have been described above with reference to specific embodiments, some or all of the elements or operations thereof may be implemented using a computer system having a general purpose hardware architecture. FIG. 12 illustrates an example computing system architecture, which may be used to implement one or more of the operations described herein. In one implementation, hardware system 1200 comprises a processor 1210, a cache memory 1215, and one or more software applications and drivers directed to the functions described herein.

Additionally, hardware system 1200 includes a high performance input/output (I/O) bus 1240 and a standard I/O bus 1270. A host bridge 1220 couples processor 1210 to high performance I/O bus 1240, whereas I/O bus bridge 1250 couples the two buses 1240 and 1270 to each other. A system memory 1260 and a network/communication interface 1230 are coupled to bus 1240. Hardware system 1200 may further include video memory (not shown) and a display device coupled to the video memory. Mass storage 1230 and I/O ports 1290 are coupled to bus 1270. Hardware system 1200 may optionally include a keyboard and pointing device, and a display device (not shown) coupled to bus 1270. Collectively, these elements are intended to represent a broad category of computer hardware systems, including but not limited to general purpose computer systems based on the Pentium® processor manufactured by Intel Corporation of Santa Clara, Calif., as well as any other suitable processor.

The elements of hardware system 1200 are described in greater detail below. In particular, network interface 1230 provides communication between hardware system 1200 and any of a wide range of networks, such as an Ethernet (e.g., IEEE 802.3) network, etc. In the case of the integrated search system 1000, the network interface 1230 interfaces between the hardware system 1200 and the network for allowing the hardware system 1200 to manage those databases. Mass storage 1230 provides permanent storage for the data and programming instructions to perform the above described functions implemented in the integrated search system 1000, whereas a system memory 1260 (e.g., DRAM) provides temporary storage for the data and programming instructions when executed by processor 1210. I/O ports 1290 are one or more serial and/or parallel communication ports that provide communication between additional peripheral devices, which may be coupled to hardware system 1200.

Hardware system 1200 may include a variety of system architectures; and various components of hardware system 1200 may be rearranged. For example, cache 1215 may be on-chip with processor 1210. Alternatively, cache 1215 and procesor 1210 may be packed together as a “processor module,” with processor 1210 being referred to as the “processor core.” Furthermore, certain implementations of the present invention may not require nor include all of the above components. For example, the peripheral devices shown coupled to standard I/O bus 1270 may couple to high performance I/O bus 1240. In addition, in some implementations only a single bus may exist, with the components of hardware system 1200 being coupled to the single bus. Furthermore, hardware system 1200 may include additional components, such as additional processors, storage devices, or memories. As discussed below, in one embodiment, the operations of the integrated search system described herein are implemented as a series of software routines run by hardware system 1200. These software routines comprise a plurality or series of instructions to be executed by a processor in a hardware system, such as processor 1210. Initially, the series of instructions are stored on a storage device, such as mass storage 1230. However, the series of instructions can be stored on any suitable storage medium, such as a diskette, CD-ROM, ROM, EEPROM, etc. Furthermore, the series of instructions need not be stored locally, and could be received from a remote storage device, such as a server on a network, via network/communication interface 1230. The instructions are copied from the storage device, such as mass storage 1230, into memory 1260 and then accessed and executed by processor 1210.

An operating system manages and controls the operation of hardware system 1200, including the input and output of data to and from software applications (not shown). The operating system provides an interface between the software applications being executed on the system and the hardware components of the system. According to one embodiment of the present invention, the operating system is the Windows® 95/98/NT/XP operation system, available from Microsoft Corporation of Redmond, Wash. However, the present invention may be used with other suitable operating systems, such as the Apple Macintosh Operating System, available from Apple Computer Inc. of Cupertino, Calif., UNIX operating systems, LINUX operating systems, and the like.

The described integrated search service and system in accordance with particular embodiments of the present invention provide search results clustered into a plurality of groups, each of which is indicated or linked by a representative image or title. Therefore, a user can easily grasp the substance of the topic relevant to each of the clusters by viewing the representative image. In addition, since the size of the representative image is adjustable based on one or more attributes of the clusters (such as the level of importance of popularity of the topic), a user can recognize the relative importance of the topics associated with the clusters of resources.

While the present invention has been shown and described with respect to a preferred embodiment, those skilled in the art will recognize that various changes and modifications may be made without departing from the spirit and scope of the invention as defined in the appended claims.

What is claimed is:

1. An integrated search service apparatus, comprising:
a clustering engine configured to group resources stored in a database into a plurality of clusters, each of the clusters including resources relevant to a common topic;
an image extracting engine configured to determine a representative image for each of the clusters; and
a web server configured to provide an array of representative images for the clusters, wherein the sizes of the representative images are adjusted based on one of more attributes of the clusters of resources.

2. The apparatus of claim 1, wherein the one of the attributes comprises the number of resources included in the clusters, and the sizes of the representative images are proportional to the respective numbers of resources.

3. The apparatus of claim 1, wherein the representative images are selected from images associated with image resource locators included in the resources.

4. The apparatus of claim 1, wherein the representative images are selected from titles associated with the resources.

5. The apparatus of claim 1, wherein the respective representative image is linked to a list of resource locators to resources included in a cluster associated with the representative image.

6. The apparatus of claim 5, wherein in response to clicking one of the representative images, the web server is configured to provide the list of resource locators to resources included in the cluster associated with the representative image.

7. The system of claim 1, further comprising:
a category search system configured to determine categories of the resources stored in the database.

8. The system of claim 1, further comprising:
an emotion search system configured to extract emotional words from the resources stored in the database.

9. The system of claim 8, wherein the emotion search system is configured to assign numerical values to the extracted emotional words.

10. An integrated search service method, comprising:
grouping resources into a plurality of clusters, each of the clusters including resources relevant to a common topic;
determining a representative image for each of the clusters; and
providing an array of representative images for the clusters, wherein the sizes of the representative images are adjusted based on one or more attributes of the clusters of resources.

11. The method of claim 10, wherein the step of determining the representative image includes selecting the representative image from images associated with image resource locators included in the resources.

12. The method of claim 10, wherein the step of determining the representative image includes selecting the respective image from titles associated with the resources.

13. The method of claim 10, further comprising:
in response to clicking one of the representative images, providing a list of resource locators to resources included in a cluster associated with the representative image,
wherein the respective representative image is linked to the list of resource locators to resources included in the cluster associated with the respective image.

14. An integrated search service method, comprising:
receiving a search query;
searching for resources relevant to the search query,
grouping the resources into a plurality of clusters, each of the clusters including resources relevant to a common topic; and
providing a graphical array of representative images for the clusters,
wherein the sizes of the representative images are adjusted based on one or more attributes of the clusters of resources.

15. The method of claim 14, wherein the step of determining the representative image includes selecting the representative image from images associated with image resource locators included in the resources.

16. The method of claim 14, wherein the step of determining the representative image includes selecting the representative image from titles associated with the resources.

17. The method of claim 14, further comprising:
in response to clicking one of the representative images, providing a list of resource locators to resources included in a cluster associated with the representative image,
wherein the respective representative image is linked to the list of resource locators to resources included in the cluster associated with the representative image.

18. Logic encoded in one or more tangible media for execution and when executed operable to cause the one or more processors to:
group resources into a plurality of clusters, each of the clusters including resources relevant to a common topic;
determine a representative image for each of the clusters; and
provide an array of representative images for the clusters, wherein the sizes of the representative images are adjusted based on one or more attributes of the clusters of resources.

19. Logic encoded in one or more tangible media for execution and when executed operable to cause the one or more processors to:
receive a search query;
search for resources relevant to the search query,
group the resources into a plurality of clusters, each of the clusters including resources relevant to a common topic; and
provide a graphical array of representative images for the clusters,
wherein the sizes of the representative images are adjusted based on one or more attributes of the clusters of resources.
